(19) United States
(12) Patent Application Publication
(10) Pub. No.: US 2007/0065739 A1
(43) Pub. Date: Mar. 22, 2007

(54) Electrophotographic photoreceptor, and image forming apparatus and process cartridge therefor using the electrophotographic photoreceptor

(76) Inventors: Kiyoshi Taniguchi, Numazu-shi (JP); Takato Kiyohara, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/524,379

(22) Filed: Sep. 21, 2006

(30) Foreign Application Priority Data
Sep. 21, 2005 (JP) 2005-274422

(51) Int. Cl. G03G 5/047

(52) U.S. Cl. 430/59.2; 430/58.05

(57) ABSTRACT

An electrophotographic photoreceptor, including an electroconductive substrate; a charge generation layer overlying the electroconductive substrate; and a charge transport layer overlying the charge generation layer, wherein the charge generation layer includes a phthalocyanine pigment and an asymmetric azo pigment having the following formula (I): 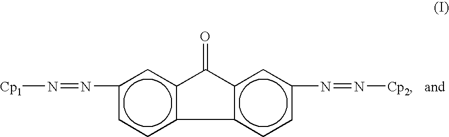 the charge generation layer or the charge transport layer includes polyalkyleneglycol, polyalkyleneglycol ester, polyalkyleneglycol ether or crown ether.

### BACKGROUND OF THE INVENTION

1. Field of the Invention

The present invention relates to an electrophotographic photoreceptor, and more particularly to an electrophotographic photoreceptor for use in a digital electrophotographic image forming apparatus irradiating imagewise light having a single wavelength to a photoreceptor, and to an image forming apparatus and a process cartridge using the electrophotographic photoreceptor.

2. Discussion of the Background

In place of conventional inorganic materials such as Se, CdS and ZnO as photoconductive materials for electrophotographic photoreceptors, organic photoconductive materials having better sensitivity, thermostability and nontoxicity than the inorganic materials prevail, and many copiers and printers are now equipped with electrophotographic photoreceptors using organic photoconductive materials. Electrophotographic photoreceptors having photosensitive layers including organic charge generation materials and charge transport materials are already in practical use.

Recently, information processing systems using electrophotographic methods have noticeably been developed. Particularly, optical printers converting information to digital signals and optically recording the information have remarkably been improved in their printing qualities and reliabilities. The digital recording technologies are applied to ordinary copiers having only printers, i.e., so-called digital copiers are developed.

Many of light sources for use in the digital recording apparatus are laser diodes in terms of their small sizes, inexpensiveness and simplicity. Most of the laser diodes have a light emission wavelength of near-infrared area not less than 750 nm, and therefore electrophotographic photoreceptors for use therein are required to have photosensitivity to a wavelength area of from 750 to 850 nm.

A squarilium pigment, a phthalocyanine pigment, an eutectic complex of a pyrylium dye and polycarbonate, a pyrrolopyrrole pigment, an azo pigment, etc. are known as suitable organic photoconductive materials. Particularly, the phthalocyanine pigment absorbs comparatively long-wavelength light and has an optical sensitivity thereto. In addition, having many variations according to a central metal and a crystal form, the phthalocyanine pigment is well studied as an organic photoconductive material for electrophotographic photoreceptors.

Specific examples of the phthalocyanine pigments include ε-type copper phthalocyanine, X-type metal-free phthalocyanine, τ-type metal-free phthalocyanine, vanadyl phthalocyanine, titanylphthalocyanine, etc. However, any of them are not satisfactory in terms of the sensitivity, chargeability and durability.

The titanylphthalocyanine having high sensitivity to long-wavelength light having a wavelength of from 600 to 800 nm is effectively used as a material for photoreceptors used in electrophotographic printers and digital copiers using LEDs and LDs as light sources, as disclosed in Japanese Laid-Open Patent Publications Nos. 03-35064, 03-35245, 03-37669, 03-269064 and 07-319179. The synthesis methods and electrophotographic properties thereof are disclosed in Japanese Laid-Open Patent Publications Nos. 57-148745, 59-36254, 59-44054, 59-31965, 61-239248 and 62-67094. The various crystal forms thereof are disclosed in Japanese Laid-Open Patent Publications Nos. 59-49544, 59-166959, 62-67094, 63-366,63-116158 and 64-17066.

On the other hand, electrophotographic photoreceptors repeatedly used in the Carlson process and similar processes are required to have good electrostatic properties such as sensitivity, acceptance potential, potential retention, potential stability, residual potential control and spectroscopy. Lives of the most photoreceptors are known to depend on deterioration of the chargeability and increase of the residual potential thereof, and even photoreceptors using the titanylphthalocyanine are not yet satisfactory.

In addition, the titanylphthalocyanine as a charge generation material in a charge generation layer of the photoreceptor has charge generatability, however, when the thickness of the charge generation layer becomes thick to decrease the potential after irradiated, it becomes difficult to control the sensitivity of the photoreceptor and the chargeability thereof deteriorates.

In order to avoid this problem, a phthalocyanine pigment and an asymmetric azo pigment are mixed to obtain a wide spectral sensitivity as disclosed in Japanese Laid-Open Patent Publications Nos. 07-128890, 07-175241, 08-29998, 09-34148 and 09-127711. However, these are not referred to the potential after irradiated and the chargeability is not yet satisfactory.

Japanese Laid-Open Patent Publications Nos. 63-273866, 63-273867, 11-338178, 63-271457 and 11-338177 disclose conventional additives such as polyalkyleneglycol, polyalkyleneglycol ether, polyalkyleneglycol ester and crown ether used for the purpose of improving the chargeability.

Particularly, when a photoreceptor is irradiated with a laser mostly used as a light source in a digital electrophotographic image forming apparatus, the potential of the photoreceptor after irradiated is higher than that thereof after irradiated with other light sources because the laser having high light intensity irradiates the photoreceptor in a short time. In order to improve the poor chargeability of s phthalocyanine pigment and defective images thereby, an intermediate layer having a charge blocking function has been adopted. However, the intermediate layer increases the potential of the photoreceptor after irradiated, and the thicker the layer, the higher the potential.

When the potential of the photoreceptor after irradiated is high, the charged potential thereof needs to be high to obtain the same contrast potential, which is not preferable in terms of the durability of the photoreceptor. In addition, the potential of the photoreceptor after irradiated tends to increase when repeatedly used, and the image density possibly deteriorates. In order to decrease the potential of the photoreceptor after irradiated, it is effective to make the charge generation layer thick. However, the chargeability deteriorates and it is difficult to make the photoreceptor have a desired sensitivity.

Because of these reasons, a need exists for a photoreceptor having high sensitivity, good potential stability, particularly low potential after irradiated, and a wide selection of the sensitivity.

### SUMMARY OF THE INVENTION

Accordingly, an object of the present invention is to provide a high-durability and a high-reliability electrophotographic photoreceptor having high sensitivity, good potential stability, particularly low potential after irradiated, and a wide selection of the sensitivity.

Another object of the present invention is to provide an electrophotographic image forming apparatus using the photoreceptor.

A further object of the present invention is to provide a process cartridge using the photoreceptor.

These objects and other objects of the present invention, either individually or collectively, have been satisfied by the discovery of an electrophotographic photoreceptor, comprising:

an electroconductive substrate;

a charge generation layer, located overlying the electroconductive substrate; and

a charge transport layer, located overlying the charge generation layer,

wherein the charge generation layer comprises a phthalocyanine pigment and an asymmetric azo pigment having the following formula (I):

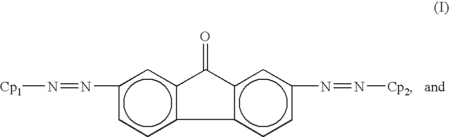

the charge generation layer or the charge transport layer comprises a member selected from the group consisting of polyalkyleneglycol, polyalkyleneglycol ester, polyalkyleneglycol ether and crown ether.

As used herein the term “overlying” includes, but does not require, contact of the layers, substrate, etc.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is across-sectional view illustrating an embodiment of layer composition of the photoreceptor of the present invention;

FIG. 2 is a cross-sectional view illustrating another embodiment of layer composition of the photoreceptor of the present invention;

FIG. 3 is an X-ray diffraction spectrum of the titanylphthalocyanine pigment prepared in Example 1;

FIG. 4 is a schematic view illustrating an embodiment of image forming apparatus for explaining the electrophotographic image forming process of the present invention; and

FIG. 5 is a schematic view illustrating a process cartridge for use in the image forming apparatus of the present invention.

### DETAILED DESCRIPTION OF THE INVENTION

The present invention provides a high-durability and a high-reliability electrophotographic photoreceptor having high sensitivity, good potential stability, particularly low potential after irradiated, and a wide selection of the sensitivity.

This is because the asymmetric azo pigment in the charge generation layer having no sensitivity to a long-wavelength light and can control the sensitivity of a photoreceptor when the mixing ratio thereof with the phthalocyanine pigment is specified. In addition, the asymmetric azo pigment does not disturb the phthalocyanine pigment's effect of decreasing the potential of a photoreceptor after irradiated. Therefore, a photoreceptor can have a low potential after irradiated and a desired sensitivity at the same time. Further combinations of the pigments and polyalkyleneglycol, polyalkyleneglycol ether, polyalkyleneglycol ester or crown ether can prepare a photoreceptor having good chargeability, sensitivity and potential after irradiated and durability.

First, the phthalocyanine pigment and the asymmetric azo pigment for use in the present invention as charge generation materials will be explained.

The phthalocyanine pigments for use in the present invention include various metal-free phthalocyanine pigments and metal phthalocyanine pigments, and titanylphthalocyanine having high sensitivity to light having a long wavelength of from 600 to 800 nm.

The titanylphthalocyanine can be synthesized by known methods. Various crystal forms thereof are known, and a crystal thereof having a Cu—Kα X-ray diffraction spectrum comprising a maximum diffraction peak at a Bragg (2θ) angle of 27.2±0.2° has high carrier generability and is preferably used as a carrier generation material for an organic photoreceptor.

The asymmetric azo pigment for use in the present invention has the formula (I), wherein Cp₁ and Cp₂ include the following formulae.

### Cp₁ and Cp₂ Examples (C1)

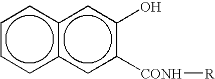

| No. | R |
|---|---|
| 1 | Phenyl |
| 2 | 2-chlorophenyl |
| 3 | 3-chlorophenyl |
| 4 | 4-chlorophenyl |
| 5 | 2-nitrophenyl |
| 6 | 3-nitrophenyl |
| 7 | 4-nitrophenyl |
| 8 | 2-trifluoromethyl |
| 9 | 3-trifluoromethyl |
| 10 | 4-trifluoromethyl |
| 11 | 2-methylphenyl |
| 12 | 3-methylphenyl |
| 13 | 4-methylphenyl |
| 14 | 2-methoxyphenyl |
| 15 | 3-methoxyphenyl |
| 16 | 4-methoxyphenyl |
| 17 | 2-cyanophenyl |
| 18 | 3-cyanophenyl |
| 19 | 4-cyanophenyl |
| 20 | 1-naphthyl |
| 21 | 2-anthraquinolyl |
| 22 | 3,5-bistrifluoromethylphenyl |
| 23 | 4-pyrazolyl |
| 24 | 2-thiazolyl |
| 25 | 4-carboxyl-2-thiazolyl |
| 26 | 2-pyridyl |
| 27 | 2-pyridinyl |
| 28 | 2-carbozolyl |
| 29 | 2-quinolyl |

### Cp₁ and Cp₂ Examples (C2)

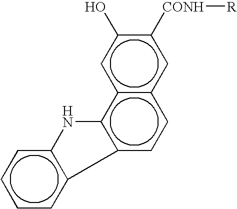

| No. | R |
|---|---|
| 1 | Phenyl |
| 2 | 2-chlorophenyl |
| 3 | 3-chlorophenyl |
| 4 | 4-chlorophenyl |
| 5 | 2-nitrophenyl |
| 6 | 3-nitrophenyl |
| 7 | 4-nitrophenyl |
| 8 | 2-trifluoromethyl |
| 9 | 3-trifluoromethyl |
| 10 | 4-trifluoromethyl |
| 11 | 2-methylphenyl |
| 12 | 3-methylphenyl |
| 13 | 4-methylphenyl |
| 14 | 2-methoxyphenyl |
| 15 | 3-methoxyphenyl |
| 16 | 4-methoxyphenyl |
| 17 | 2-cyanophenyl |
| 18 | 3-cyanophenyl |
| 19 | 4-cyanophhenyl |
| 20 | 1-naphthyl |
| 21 | 2-anthraquinolyl |
| 22 | 3,5-bistrifluoromethylphenyl |
| 23 | 4-pyrazolyl |
| 24 | 2-thiazolyl |
| 25 | 4-carboxy-2-thiazolyl |
| 26 | 2-pyridyl |
| 27 | 2-pyridinyl |
| 28 | 2-carbozolyl |
| 29 | 2-quinolyl |

### Cp₁ and Cp₂ Examples (C3)

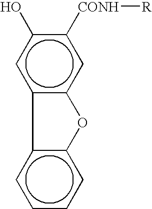

| No. | R |
|---|---|
| 1 | Phenyl |
| 2 | 2-chlorophenyl |
| 3 | 3-chlorophenyl |
| 4 | 4-chlorophenyl |
| 5 | 2-nitrophenyl |
| 6 | 3-nitrophenyl |
| 7 | 4-nitrophenyl |
| 8 | 2-trifluoromethyl |
| 9 | 3-trifluoromethyl |
| 10 | 4-trifluoromethyl |
| 11 | 2-methylphenyl |
| 12 | 3-methylphenyl |
| 13 | 4-methylphenyl |
| 14 | 2-methoxyphenyl |
| 15 | 3-methoxyphenyl |
| 16 | 4-methoxyphenyl |
| 17 | 2-cyanophenyl |
| 18 | 3-cyanophenyl |
| 19 | 4-cyanophenyl |
| 20 | 1-naphthyl |
| 21 | 2-anthraquinolyl |
| 22 | 3,5-bistrifluoromethylphenyl |
| 23 | 4-pyrazolyl |
| 24 | 2-thiazolyl |
| 25 | 4-carboxyl-2-thiazolyl |
| 26 | 2-pyridyl |
| 27 | 2-pyridinyl |
| 28 | 2-carbozolyl |
| 29 | 2-quinolyl |

### Cp₁ and Cp₂ Examples (C4)

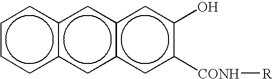

| No. | R |
|---|---|
| 1 | Phenyl |
| 2 | 2-chlorophenyl |
| 3 | 3-chlorophenyl |
| 4 | 4-chlorophenyl |
| 5 | 2-nitrophenyl |
| 6 | 3-nitrophenyl |
| 7 | 4-nitrophenyl |
| 8 | 2-trifluoromethyl |
| 9 | 3-trifluoromethyl |
| 10 | 4-trifluoromethyl |
| 11 | 2-methylphenyl |
| 12 | 3-methylphenyl |
| 13 | 4-methylphenyl |
| 14 | 2-methoxyphenyl |
| 15 | 3-methoxyphenyl |
| 16 | 4-methoxyphenyl |
| 17 | 2-cyanophenyl |
| 18 | 3-cyanophenyl |
| 19 | 4-cyanophenyl |
| 20 | 1-naphthyl |
| 21 | 2-anthraquinolyl |
| 22 | 3,5-bistrifluoromethylphenyl |
| 23 | 4-pyrazolyl |
| 24 | 2-thiazolyl |
| 25 | 4-carboxy-2-thiazolyl |
| 26 | 2-pyridyl |
| 27 | 2-pyridinyl |
| 28 | 2-carbozolyl |
| 29 | 2-quinolyl |

### Cp₁ and Cp₂ Examples (C5)

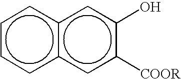

| No. | R |
|---|---|
| 1 | methyl |
| 2 | Ethyl |
| 3 | Propyl |
| 4 | Isopropyl |
| 5 | Butyl |
| 6 | Isobutyl |
| 7 | Scc-butyl |
| 8 | Tert-butyl |
| 9 | Pentyl |
| 10 | Isoamyl |
| 11 | Hexyl |
| 12 | Heptyl |
| 13 | Octyl |
| 14 | Capryl |
| 15 | Nonyl |
| 16 | Decyl |
| 17 | Undecyl |
| 18 | Lauryl |
| 19 | Tridecyl |
| 20 | Pentadecyl |

### Cp₁ and Cp₂ Examples (C6)

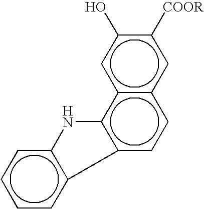

| No. | R |
|---|---|
| 1 | Methyl |
| 2 | Ethyl |
| 3 | Propyl |
| 4 | Isopropyl |
| 5 | Butyl |
| 6 | Isobutyl |
| 7 | Scc-butyl |
| 8 | Tert-butyl |
| 9 | Pentyl |
| 10 | Isoamyl |
| 11 | Hexyl |
| 12 | Heptyl |
| 13 | Octyl |
| 14 | Capryl |
| 15 | Nonyl |
| 16 | Decyl |
| 17 | Undecyl |
| 18 | Lauryl |
| 19 | Tridecyl |
| 20 | Pentadecyl |

### Cp₁ and Cp₂ Examples (C7-1, C7-2, C-8)

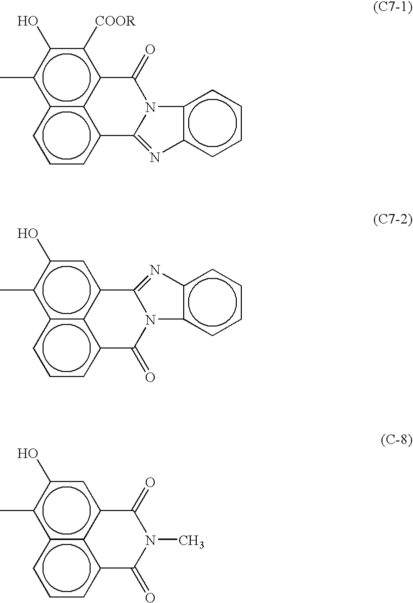

These asymmetric azo pigments have almost no sensitivity to light having a long wavelength not less than 750 nm, which is mostly used in digital recorders. Therefore, the sensitivity of a photoreceptor becomes lower as the mixing ratio of the asymmetric azo pigment to that of the phthalocyanine pigment in a charge generation layer increases more. The mixing ratio of the asymmetric azo pigment to that of the phthalocyanine pigment is preferably from 90/10 to 10/90, and more preferably from 70/30to 20/80. Since the sensitivity changed due to other factors such as a thickness of the photosensitive layer, the mixing ratio changes depending on the total design thereof.

Specific examples of the polyalkyleneglycol for use in the present invention include polyethyleneglycol; polypropyleneglycol; polybutyleneglycol; and a random copolymer or a block copolymer of oxyethylene and oxypropylene; and various marketed products can be used.

The polyethyleneglycol preferably has a molecular weight of from 106 to 5,000,000, and more preferably from 200to 50,000. Particularly, the polyethyleneglycol having a molecular weight not less than 10,000 is occasionally called polyethylene oxide.

The polypropyleneglycol preferably has a molecular weight of from 130 to 500,000, and more preferably from 500 to 10,000.

The polybutyleneglycol preferably has a molecular weight of from 160 to 100,000, and more preferably from 500 to 3,000.

The random copolymer or block copolymer of oxyethylene and oxypropylene preferably has a molecular weight of from 200 to 500,000, and more preferably from 500 to 50,000. The oxyethylene preferably has an average additional number of moles of from 0.1 mol % to 99.9 mol %.

Specific examples of the polyalkyleneglycol ether for use in the present invention include a polyethyleneglycol monoether having the following formula (A) and a polypropyleneglycol monoether having the following formula (B):
R—O—(CH₂CH₂O)n-H (A)
R—O—(CH₂CH₂CH₂O)n-H (B)
wherein R represents an alkyl group having 1 to 30, preferably 1 to 20 carbon atoms, a substituted or an unsubstituted aryl group, a phenyl group substituted with an alkyl group having 1 to 20 carbon atoms; and n represents an integer not less than 1, preferably from 1 to 100.

These polyalkyleneglycol ethers are known, and various marketed products thereof are used in the present invention. The polyalkyleneglycol ethers preferably has a molecular weight of from 70 to 10,000, and more preferably from 20 to 5,000. Specific examples of the polyethyleneglycol monoethers having the formula (A) include EMULMIN 40, 50, 60, 70, 110, 140, 180, M-20, 240, L-90-S800-100 and L-380 from SANYO KASEI CO., LTD.; ADEKA ESTOL OEG and SEG series from ADEKA CORPORATION; NOYGEN ET series, NOYGEN EA series and EMULSIT L series from DAI-ICHI KOGYO SEIYAKU CO., LTD.; NONIONE-206, E-210, E-230, P-208, P-210, P-213, S-207, S-215, S-220, K-204, K-215, K-220, K-230, T-2085, NK-60, NK-100, NONION NS series, HS series, M-400, M-550, M-200 C-2300 from NOF Corporation; NONIPOL 20, 30, 40, 55, 60, 70, 85, 90, 95, 100, 110, 120, 130, 140, 160, 200, 290, 300, 400, 450, 500, 700, 800, D160, OCTAPOL 45, 50, 60, 80, 100, 200, 300, 400, DODECAPOL 61, 90, 120, 200 from SANYO KASEI CO., LTD.; etc.

Specific examples of the polypropyleneglycol monoethers having the formula (B) include NEWPOL LB-65, NEWPOL L285, NEWPOL LB385, NEWPOL LB625, NEWPOL L1145, NEWPOL LB1715, NEWPOL B3000, NEWPOL LB300X, NEWPOL LB400XY, NEWPOL LB650X, NEWPOL L1800X from SANYO KASEI CO., LTD., etc. However, the present invention is not limited to these specific examples.

Specific examples of the polyalkyleneglycol ester include polyethyleneglycol monoesters and polyethyleneglycol diesters such as a polyalkyleneglycol monocarboxylic acid ester and a polyalkyleneglycol dicarboxylic acid ester, and a variety of which are commercially available.

Specific examples of the polyalkyleneglycol monocarboxylic acid ester include IONET MS-400, MS-1000, MO-200, MO-400, MO-600 and TE-106 from SANYO KASEI CO., LTD.; NOYGEN ES series from DAI-ICHI KOGYO SEIYAKU CO., LTD.; and NONION L series, NONION O series and NONION T series from NOF Corporation; etc. Specific examples of the polyalkyleneglycol dicarboxylic acid ester include DL-200, DS-300, DS-400, DO-200, DO-400, DO-600, DO-1000 and GE-70 from SANYO KASEI CO., LTD.; and NONION DS-60HN (distearate) from NOF Corporation; etc. However, the present invention is not limited to these specific examples.

The crown ether for use in the present invention preferably has 3 to 8 oxygen atoms forming a ring, and specific examples thereof include crown ethers having the following formulae:

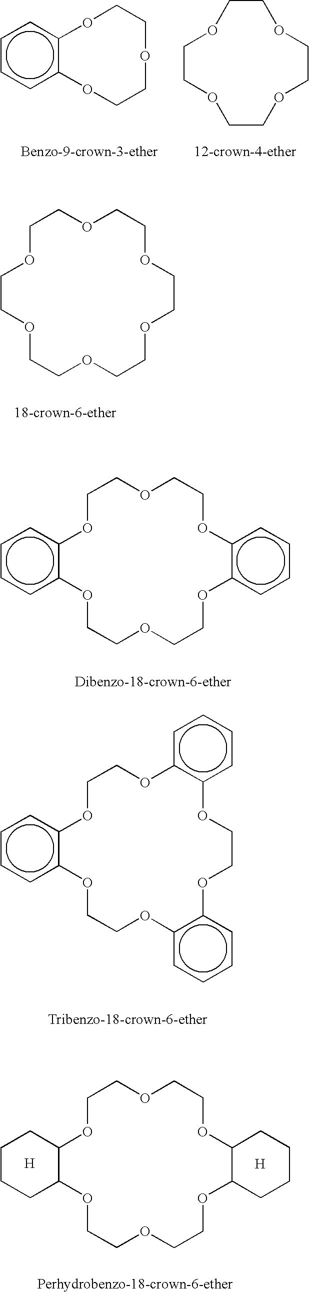

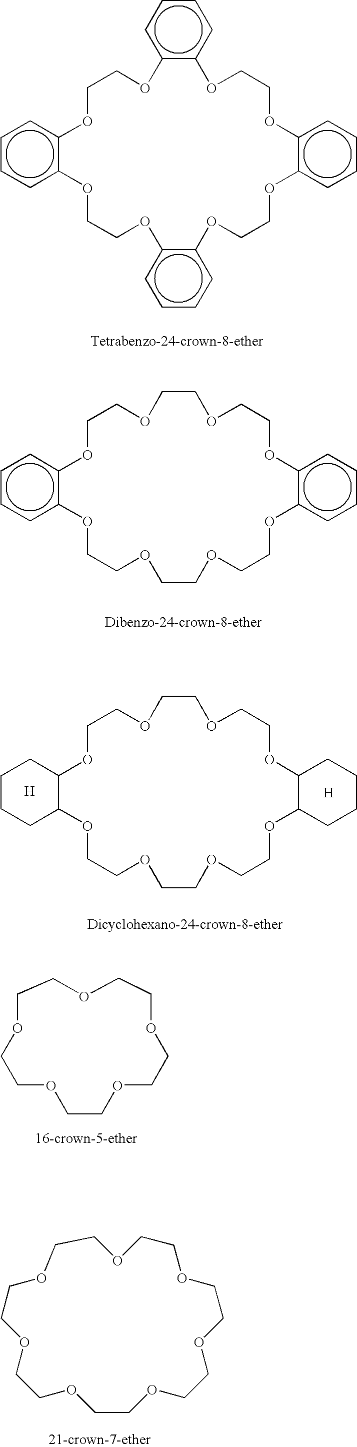

The polyalkyleneglycol, polyalkyleneglycol ester, polyalkyleneglycol ether or crown ether for use in the present invention may be included in any layers such as a charge generation layer, a charge transport layer and an intermediate layer in a photosensitive layer. The content thereof is preferably from 0.1 to 10 parts by weight, and more preferably from 0.2 to 6 parts by weight based on total weight of the layer including one of them. When less than 0.1 parts by weight, the resultant photoreceptor has insufficient chargeability. When more than 10 parts by weight, the residual potential thereof increases.

The constitution of the electrophotographic photoreceptor of the present invention will be explained, referring to the drawings.

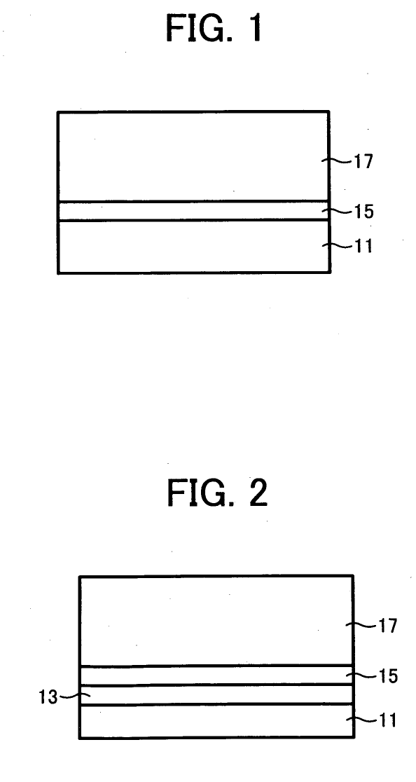

FIG. 1 is a cross-sectional view illustrating an embodiment of layer composition of the photoreceptor of the present invention, which includes at least a charge generation layer (CGL) (15) and a charge transport layer (CTL) (17) on an electroconductive substrate (11). FIG. 2 is a cross-sectional view illustrating another embodiment of layer composition of the photoreceptor of the present invention, which includes an intermediate layer (13) between a CGL (15) and an electroconductive substrate (11) in addition to the layer composition in FIG. 1.

Suitable materials for use as the electroconductive substrate (11) include materials having a volume resistance not greater than 10¹⁰Ω·cm. Specific examples of such materials include a plastic cylinder, a plastic film or a paper sheet, on the surface of which a metal such as aluminum, nickel, chromium, nichrome, copper, gold, silver, platinum or a metal oxide such as tin oxides, indium oxides is deposited or sputtered. In addition, a plate of a metal such as aluminum, aluminum alloys, nickel and stainless steel and a metal cylinder, which is prepared by tubing a metal such as the metals mentioned above by a method such as impact ironing or direct ironing, and then treating the surface of the tube by cutting, super finishing, polishing and the like treatments, can also be used as the substrate. Further, endless belts of a metal such as nickel and stainless steel, which have been disclosed in Japanese Laid-Open Patent Publication No. 52-36016, can also be used as the substrate (11).

The CGL (15) includes at least an asymmetric azo pigment having the formula (I) and a phthalocyanine pigment as charge generation materials dispersed in a binder resin. Therefore, the CGL (15) is formed by dispersing these constituents in a proper solvent with a ball mill, an attritor, a sand mill or an ultrasound to prepare a dispersion; and coating and drying the dispersion on the substrate (11) or the intermediate layer (13) The two pigments may be dispersed together in a solvent. Alternatively, they may be separately dispersed to prepare two dispersions to be mixed afterward.

Specific examples of the binder resins used in the CGL (15) include polyamide, polyurethane, epoxyresins, polyketone, polycarbonate, silicone resins, acrylic resins, polyvinylbutyral, polyvinylformal, polyvinylketone, polystyrene, polysulfone, poly-N-vinylcarbazole, polyacrylamide, polyvinyl benzal, polyester, phenoxy resins, vinyl chloride-vinyl acetate copolymers, polyvinyl acetate, polyphenyleneoxide, polyamides, polyvinylpyridine, cellulose resins, casein, polyvinyl alcohol, polyvinyl pyrrolidone, etc.

Particularly, the polyvinylbutyral is preferably used, and a butyral resin having a butylation less than 62 mol % is more preferably used.

The CGL preferably Includes the binder resin in an amount of from 10 to 500 parts by weight, and preferably from 25 to 300 parts by weight, per 100 parts by weight of the charge generation material therein. The CGL preferably has a thickness of form 0.01 to 5 μm, and more preferably from 0.1 to 2 μm. Specific examples of the solvents used for forming the CGL include isopropanol, acetone, methyl ethyl ketone, cyclohexanone, tetrahydrofuran, dioxane, ethylcellosolve, ethylacetate, methylacetate, dichloromethane, dichloroethane, monochlorobenzene, cyclohexane, toluene, xylene, ligroin, etc.

The CGL coating liquid (dispersion) can be coated by a dip coating method, a spray coating method, a bead coating method, a nozzle coating method, a spinner coating method, a ring coating method, etc.

The charge transport layer (CTL) can be formed by dissolving or dispersing a charge transport material and a binder resin in a proper solvent to prepare a coating liquid, coating the coating liquid on the CGL, and drying the coated liquid. Additives such as a plasticizer and an antioxidant may optionally be included in the CTL.

The charge transport material includes a positive-hole transport material and an electron transport material. Specific examples of the electron transport material include electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetanitroxanthone, 2,4,8-trinitrothioxanthone, 2,6,8-trinitro-4H-indeno[1,2-b]thiophene-4-one, 1,3,7-trinitrodibenzothiphene-5,5-dioxide, benzoquinone derivatives, etc.

Specific examples of the positive-hole transport material include known materials such as poly-N-carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, etc.

Specific examples of the binder resin include thermoplastic resins or thermosetting resins such as polystyrene, a styrene-acrylonitrile copolymer, a styrene-butadiene copolymer, a styrene-maleic anhydride copolymer, polyester, polyvinyl chloride, a vinylchloride-vinylacetate copolymer, polyvinyl acetate, polyvinylidene chloride, polyarylate, a phenoxyresin, polycarbonate, acellulose acetate resin, anethyl cellulose resin, a polyvinyl butyral resin, a polyvinyl formal resin, polyvinyl toluene, poly-N-vinyl carbazole, an acrylic resin, a silicone resins, an epoxy resin, a melamine resin, a urethane resin, a phenolic resin, an alkyd resin and various polycarbonate copolymers disclosed in Japanese Laid-Open Patent Publications Nos. 5-158250 and 6-51544.

The CTL preferably includes a charge transport material in an amount of from 20 to 300 parts by weight, and more preferably from 40 to 150 parts by weight per 100 parts by weight of the binder resin. The CTL preferably has a thickness of from 5 to 50 μm.

Suitable solvents for use in the coating liquid include tetrahydrofuran, dioxane, toluene, dichloromethane, monochlorobenzene, dichloroethane, cyclohexanone, methyl ethyl ketone, acetone, etc.

The CTL (17) in the present invention may include a leveling agent. Specific examples thereof include silicone oils such as dimethyl silicone oil and methyl phenyl silicone oil; polymers or oligomers including a perfluoroalkyl group in their side chain; and the like. The CTL preferably includes the leveling agent in an amount of from 0 to 1 parts by weight per 100 parts by weight of the binder resin.

The intermediate layer (13) may include a fine powder such as titanium oxide, aluminum oxide, silica, zirconium oxide, tin oxide an indium oxide; a silane coupling agent; a titanium coupling agent; a chrome coupling agent; a titanyl chelate compound; a zirconium chelate compound; a titanyl alkoxide compound; an organic titanyl compound; etc. to inhibit moire and decrease the residual potential.

Particularly, the intermediate layer preferably includes titanium oxide and a binder resin, because the titanium oxide having a large refractive index and a proper conductivity effectively inhibits moire and decrease the residual potential.

The intermediate layer (13) can be formed by the same method of forming the CGL and CTL, and preferably has a thickness of from 0 to 10 μm.

The electrophotographic image forming apparatus of the present invention includes at least an electrophotographic photoreceptor, a charger, an irradiator, a reversal image developer, a transferer and a cleaner, and which may use any conventional methods. The charger includes a corotron using a corona discharge, a scorotron, a contact charger using an electroconductive roller or a brush, etc. The image developer contacts or does not contact a magnetic or a non-magnetic one-component or two-component developer to the photoreceptor, and which use a reversal development. The transferer uses a corona discharge or a transfer roller. The cleaner typically includes blade cleaning, and the image developer may be used as the cleaner as well.

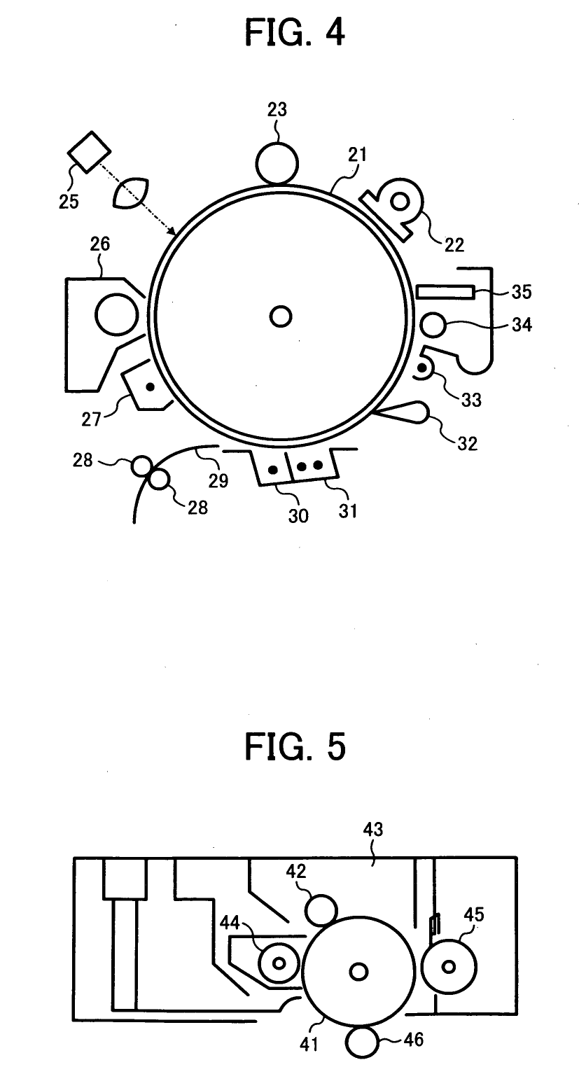

FIG. 4 is a schematic view illustrating an embodiment of image forming apparatus for explaining the electrophotographic image forming process of the present invention.

In FIG. 4, a photoreceptor (21) includes at least an electroconductive substrate, an intermediate layer and a photosensitive layer in this order, wherein the intermediate layer includes a N-alkoxymethylated nylon including a component having a molecular weight not grater than 5,000 in an amount of from 3 to 10% by weight. The photoreceptor (21) has the shape of a drum, and may have the shape of a sheet or an endless belt. Known chargers such as corotrons, scorotrons, solid state chargers, charging rollers and transfer rollers can be used for a charging roller (23), a pre-transfer charger (27), a transfer charger (30), a separation charger (31) and a pre-cleaning charger (33).

The above-mentioned image forming units may be fixedly set in a copier, a facsimile or a printer. However, the image forming units may be set therein as a process cartridge. The process cartridge means an image forming unit (or device) including at least a photoreceptor; and one of a charger, an imagewise light irradiator, an image developer, an image transferer, a cleaner and a discharger. Various process cartridges can be used in the present invention. FIG. 5 illustrates an embodiment of the process cartridge for use in the image forming apparatus of the present invention, wherein a photoreceptor drum 41 rotates in the direction indicated by an arrow, and a charger 42, an irradiator 43, an image developer 45, a transferer 46 and a cleaner 44 are located around the photoreceptor drum 41, and a transfer sheet is fed thereto.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

The following materials were dispersed by a ball mill for 72 hrs to prepare an intermediate layer coating liquid.

| | |
|---|---|
| Titanium oxide | 70 |
| (CR-EL from Ishihara Sangyo Kaisha, ltd.) | |
| Alkyd resin | 15 |
| (Bekkolite M6401-50-S (solid content of 50%) | |
| from Dainippon Ink And Chemicals, inc.) | |
| Melamine resin | 10 |
| (Super Bekkamin L-121-60 (solid content of 60%) | |
| from Dainippon Ink And Chemicals, inc.) | |
| Methyl ethyl ketone | 100 |

The intermediate layer coating liquid was coated an aluminum drum having a diameter of 80 mm and a length of 360 mm, and dried at 130° C. for 20 min to form an intermediate layer 3.5 μm thick thereon.

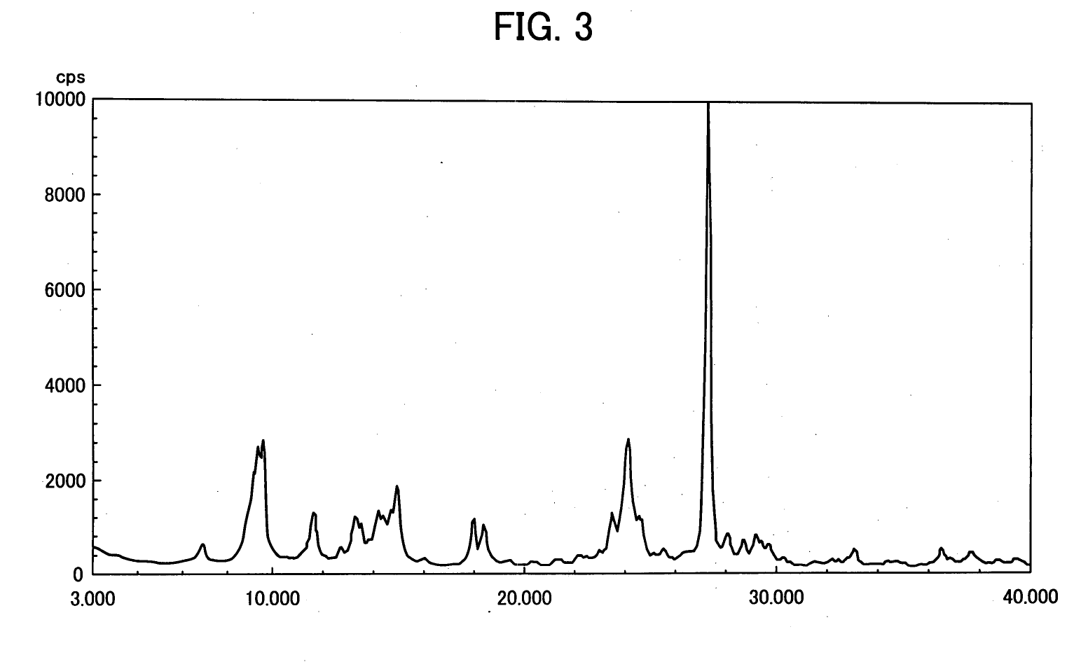

Next, the following materials were dispersed with zirconia beads having a diameter of 0.5 mm to prepare a CGL dispersion 1.

| | |
|---|---|
| Titanylphthalocyanine pigment | 15 |
| having an X-ray diffraction spectrum | |
| in FIG. 3 | |
| Polyvinyl butyral | 10 |
| (BX-1 from Sekisui Chemical Co., Ltd.) | |
| 2-butanone | 300 |

In a glass pot having a diameter of 15 cm, a half volume (of the glass pot) of YTZ (partially stabilized zirconia) having a diameter of 10 mm, 45 g of an azo pigment having the following formula (II) and 350 g of methyl ethyl ketone (MEK) were dispersed for 10 days.

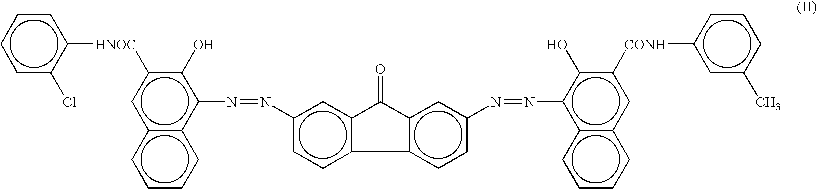

Then, 750 g of cyclohexanone (anone) were added to the dispersion and 1,000 g thereof were taken out and a mixture of MEK/anone/polyvinylbutyral (XYHL from Union Carbide Corp.) (493/1169/4 g) were dropped therein while stirred to prepare a CGL dispersion 2.

The CGL dispersions 1 and 2 were mixed at a weight ratio (dispersion 1/dispersion 2) of 3/7 to prepare a CGL coating liquid. The mixing ratio of the titanylphthalocyanine pigment to the azo pigment is 41/59.

The CGL coating liquid was dip-coated on the intermediate layer and dried at 90° C. for 20 min to form a CGL 0.2 μm thick.

The following materials were dispersed to prepare a CTL coating liquid.

| | |
|---|---|
| Charge transport material | 7 |
| having the following formula (III): | |
| 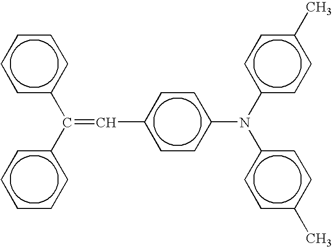 | |
| Polycarbonate | 10 |
| (Z-type having a viscodity-average | |
| molecular weight of 50,000) | |
| Polyethyleneglycol | 0.2 |
| (PEG6000S from SANYO KASEI CO., LTD.) | |
| Silicone oil | 0.002 |
| (KF-50 from Shin-Etsu Chemical Co., Ltd.) | |
| Tetrahydrofuran | 100 |

The CTL coating liquid was coated on the CGL and dried at 130° C. for 15 min to form a CTL 25 μm thick.

Thus, an electrophotographic photoreceptor was prepared.

### Example 2

The procedure for preparation of the electrophotographic photoreceptor in Example 1 was repeated to prepare an electrophotographic photoreceptor except for replacing the polyethyleneglycol in the CTL coating liquid with polypropyleneglycol (having an average molecular weight of 4,000 from Wako Pure Chemical Industries, Ltd.).

### Example 3

The procedure for preparation of the electrophotographic photoreceptor in Example 1 was repeated to prepare an electrophotographic photoreceptor except for replacing the polyethyleneglycol in the CTL coating liquid with polyethyleneglycol monoether (EMULMIN L380 from SANYO KASEI CO., LTD.).

### Example 4

The procedure for preparation of the electrophotographic photoreceptor in Example 1 was repeated to prepare an electrophotographic photoreceptor except for replacing the polyethyleneglycol in the CTL coating liquid with polypropyleneglycol monoether (NEWPOL LB1800X from SANYO KASEI CO., LTD.).

### Example 5

The procedure for preparation of the electrophotographic photoreceptor in Example 1 was repeated to prepare an electrophotographic photoreceptor except for replacing the polyethyleneglycol in the CTL coating liquid with polyethyleneglycol monocarboxylic acid ester (IONET MS400 from SANYO KASEI CO., LTD.).

### Example 6

The procedure for preparation of the electrophotographic photoreceptor in Example 1 was repeated to prepare an electrophotographic photoreceptor except for replacing the, polyethyleneglycol in the CTL coating liquid with polyethyleneglycol dicarboxylic acid ester (IONET DS300 from SANYO KASEI CO., LTD.).

### Example 7

The procedure for preparation of the electrophotographic photoreceptor in Example 1 was repeated to prepare an electrophotographic photoreceptor except for replacing the polyethyleneglycol in the CTL coating liquid with cyclohexano-18-crown-ether.

### Example 8

The procedure for preparation of the electrophotographic photoreceptor in Example 1 was repeated to prepare an electrophotographic photoreceptor except for replacing the polyethyleneglycol in the CTL coating liquid with dibenzo-24-crown-8-ether.

### Example 9

The procedure for preparation of the electrophotographic photoreceptor in Example 1 was repeated to prepare an electrophotographic photoreceptor except for replacing the titanylphthalocyanine pigment in the CGL coating liquid with a τ-type metal-free phthalocyanine pigment.

### Example 10

The procedure for preparation of the electrophotographic photoreceptor in Example 1 was repeated to prepare an electrophotographic photoreceptor except for replacing the azo pigment in the CGL coating liquid with an azo pigment having the following formula (IV):

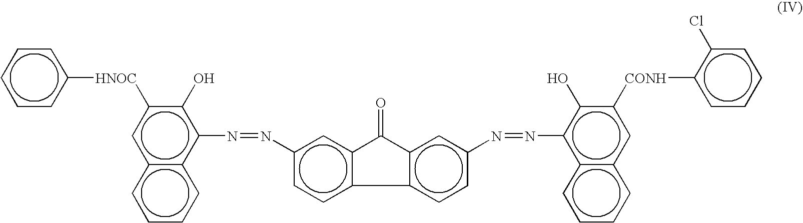

### Example 11

The procedure for preparation of the electrophotographic photoreceptor in Example 1 was repeated to prepare an electrophotographic photoreceptor except for including 1 part by weight of polyethyleneglycol (PEG6000S from SANYO KASEI CO., LTD.) in the intermediate layer coating liquid and excluding 0.2 parts by weight thereof in the CTL coating liquid.

### Example 12

The procedure for preparation of the electrophotographic photoreceptor in Example 1 was repeated to prepare an electrophotographic photoreceptor except for changing the weight ratio of the CGL dispersion 1 to the CGL dispersion 2 from 3/7 to 4/6. The mixing ratio of the titanylphthalocyanine pigment to the azo pigment is 52/48.

### Example 13

The procedure for preparation of the electrophotographic photoreceptor in Example 1 was repeated to prepare an electrophotographic photoreceptor except for changing the weight ratio of the CGL dispersion 1 to the CGL dispersion 2 from 3/7 to 2/8. The mixing ratio of the titanylphthalocyanine pigment to the azo pigment is 32/68.

### Comparative Example 1

The procedure for preparation of the electrophotographic photoreceptor in Example 1 was repeated to prepare an electrophotographic photoreceptor except for excluding polyethyleneglycol in the CTL.

### Comparative Example 2

The procedure for preparation of the electrophotographic photoreceptor in Example 1 was repeated to prepare an electrophotographic photoreceptor except for excluding polyethyleneglycol in the CTL and using the CGL dispersion 1 for the CGL coating liquid.

Each of the thus prepared electrophotographic photoreceptors was installed in a process cartridge, and the process cartridge was installed in an image forming apparatus using a LD light source emitting light having a wavelength of 780nm and a polygon mirror. The surface potentials of irradiated and unirradiated parts of the photoreceptor before and after 10,000 images were continuosly produced thereby were measured. The results are shown in Table 1.

The light intensity of the light source was controlled when using the photoreceptors prepared in Examples 12 and 13, having different sensitivities.

The sensitivities of the photoreceptors prepared in Examples 1, 12 and 13 were measured at a charge potential of 800 V.

| | E ½ (μj/cm²) |
|---|---|
| Example 1 | 0.09 |
| Example 12 | 0.07 |
| Example 13 | 0.12 |

TABLE 1

| | Initial | | After 10,000 | |
|---|---|---|---|---|
| | Irradiated part | Unirradiated part | Irradiated part | Unirradiated part |
| | potential (V) | potential (V) | potential (V) | potential (V) |
| Example 1 | 605 | 45 | 602 | 46 |
| Example 2 | 603 | 48 | 600 | 48 |
| Example 3 | 598 | 50 | 595 | 51 |
| Example 4 | 601 | 51 | 598 | 52 |
| Example 5 | 608 | 46 | 605 | 48 |
| Example 6 | 597 | 47 | 595 | 50 |
| Example 7 | 602 | 48 | 601 | 50 |
| Example 8 | 595 | 45 | 594 | 49 |
| Example 9 | 598 | 55 | 595 | 57 |
| Example 10 | 603 | 47 | 601 | 51 |
| Example 11 | 604 | 50 | 601 | 51 |
| Example 12 | 598 | 51 | 600 | 52 |
| Example 13 | 605 | 45 | 601 | 48 |
| Comparative | 580 | 52 | 475 | 67 |
| Example 1 | | | | |
| Comparative | 590 | 80 | 575 | 95 |
| Example 2 | | | | |

As mentioned above, an electrophotographic photoreceptor having the constituents of the present invention is a high-durability and a high-reliability electrophotographic photoreceptor having high sensitivity, good potential stability, particularly low potential after irradiated, and a wide selection of the sensitivity.

This application claims priority and contains subject matter related to Japanese Patent Application No. 2005-274422 filed on Sep. 21, 2005, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An electrophotographic photoreceptor, comprising:
an electroconductive substrate;
a charge generation layer located overlying the electroconductive substrate; and
a charge transport layer located overlying the charge generation layer,
wherein the charge generation layer comprises at least one phthalocyanine pigment and at least one asymmetric azo pigment having the following formula (I): 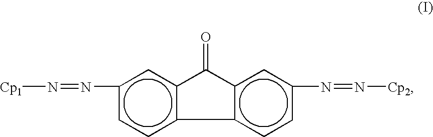
and wherein the charge generation layer and/or the charge transport layer comprises at least one member selected from the group consisting of polyalkyleneglycol, polyalkyleneglycol ester, polyalkyleneglycol ether and crown ether.

2. The electrophotographic photoreceptor of claim 1, wherein the charge generation layer and/or the charge transport layer comprises at least one member selected from the group consisting of polyalkyleneglycol, polyalkyleneglycol ether, polyalkyleneglycol ester and crown ether in an amount of from 0.1 to 10% by weight.

3. The electrophotographic photoreceptor of claim 1, wherein the charge generation layer and/or charge transport layer comprises a polyalkyleneglycol that is a member selected from the group consisting of polyethyleneglycol having a molecular weight of from 200 to 50,000; polypropyleneglycol having a molecular weight of from 500 to 10,000; polybutyleneglycol having a molecular weight of from 500 to 3,000; and a random copolymer or a block copolymer of oxyethylene and oxypropylene, having an average additional number of moles of the oxyethylene group of from 0.1 mol % to 99.9 mol %.

4. The electrophotographic photoreceptor of claim 1, wherein the charge generation layer and/or charge transport layer comprises a polyalkyleneglycol ester that is a polyalkyleneglycol monoester or a polyalkyleneglycol diester.

5. The electrophotographic photoreceptor of claim 1, wherein the charge generation layer and/or charge transport layer comprises a polyalkyleneglycol ether that is a polyethyleneglycol monoether having the following formula (A) or a polypropyleneglycol monoether having the following formula (B), each having a molecular weight of from 200 to 5,000:
R—O—(CH₂CH₂O)n-H (A)
R—O—(CH₂CH₂CH₂O)n-H (B)
wherein R represents an alkyl group having 1 to 30, a substituted or an unsubstituted aryl group, a phenyl group substituted with an alkyl group having 1 to 20 carbon atoms; and n represents an integer not less than 1.

6. The electrophotographic photoreceptor of claim 1, wherein the charge generation layer and/or charge transport layer comprises a crown ether has 3 to 8 oxygen atoms forming a ring.

7. The electrophotographic photoreceptor of claim 1, comprising at least one titanylphthalocyanine pigment.

8. The electrophotographic photoreceptor of claim 7, comprising a titanylphthalocyanine pigment that has a crystal form having a maximum diffraction peak at a Bragg (2θ) angle of 27.2±0.2° in a Cu—Kα X-ray diffraction spectrum.

9. The electrophotographic photoreceptor of claim 1, further comprising an intermediate layer located between the electroconductive substrate and the charge generation layer, wherein the intermediate layer comprises a titanium oxide and a binder resin and has a thickness of up to 10 μm.

10. An image forming apparatus, comprising:
the electrophotographic photoreceptor according to claim 1;
a charger configured to charge the electrophotographic photoreceptor;
an irradiator configured to irradiate the electrophotographic photoreceptor to form an electrostatic latent image thereon;
an image developer configured to develop the electrostatic latent image with a developer comprising a toner to form a toner image on the electrophotographic photoreceptor; and
a transferer configured to transfer the toner image onto a transfer material.

11. A process cartridge, comprising:
the electrophotographic photoreceptor according to claim 1; and
at least one of a charger, an irradiator, an image developer, an image transferer, a cleaner and a discharger.
